(19) United States
(12) Patent Application Publication
(10) Pub. No.: US 2025/0055487 A1
(43) Pub. Date: Feb. 13, 2025

(54) RADIO FREQUENCY CIRCUIT AND COMMUNICATION APPARATUS

(71) Applicant: Murata Manufacturing Co., Ltd., Nagaokakyo-shi (JP)

(72) Inventors: Yuusuke SUZUKI, Nagaokakyo-shi (JP); Masateru HIGASHI, Nagaokakyo-shi (JP); Takumi FUKUNAGA, Nagaokakyo-shi (JP)

(73) Assignee: Murata Manufacturing Co., Ltd., Nagaokakyo-shi (JP)

(21) Appl. No.: 18/929,659

(22) Filed: Oct. 29, 2024

Related U.S. Application Data
(63) Continuation of application No. PCT/JP2023/012849, filed on Mar. 29, 2023.

(30) Foreign Application Priority Data
Jun. 9, 2022 (JP) 2022-093772

(51) Int. Cl. H04B 1/00; H04B 1/04

(52) U.S. Cl. CPC H04B 1/0078; H04B 1/0483

(57) ABSTRACT

A radio frequency circuit includes a switch having selection terminals, a switch, a filter connected to the selection terminal, a filter connected to the selection terminal, and a filter. The switch is connected in series to and between the filter and a path connecting the selection terminal and the filter.

### CROSS-REFERENCE TO RELATED APPLICATIONS

This is a continuation application of PCT/JP2023/012849, filed on Mar. 29, 2023, designating the United States of America, which is based on and claims priority to Japanese Patent Application No. JP 2022-093772 filed on Jun. 9, 2022. The entire contents of the above-identified applications, including the specifications, drawings and claims, are incorporated herein by reference in their entirety.

### TECHNICAL FIELD

The present disclosure relates to a radio frequency circuit and a communication apparatus.

### BACKGROUND ART

Patent Document 1 discloses a configuration including a switch having a plurality of selection terminals and a filter connected to each of the plurality of selection terminals.

### CITATION LIST

### Patent Document

Patent Document 1: Japanese Unexamined Patent Application (Translation of PCT Application) No. 2019-528656

### SUMMARY OF DISCLOSURE

### Technical Problem

However, it is possible that loss is not reduced in the related art described above.

Hence, the present disclosure provides a radio frequency circuit and a communication apparatus that are capable of reducing loss.

### Solution to Problem

A radio frequency circuit according to an aspect of the present disclosure includes: a first switch having a first selection terminal and a second selection terminal; a second switch; a first filter connected to the first selection terminal; a second filter connected to the second selection terminal; and a third filter. The second switch is connected in series to and between the third filter and a path connecting the second selection terminal and the second filter.

A radio frequency circuit according to another aspect of the present disclosure includes: a first switch having a first selection terminal and a second selection terminal; a second switch; a first filter connected to the first selection terminal; a second filter connected to the second selection terminal; and an external connection terminal. The second switch is connected in series to and between the second filter and the external connection terminal and a path connecting the second selection terminal and the second filter.

A radio frequency circuit according to another aspect of the present disclosure includes a first switch having a first selection terminal and a second selection terminal; a second switch of a single pole single throw (SPST) type; a first filter connected to the first selection terminal; a second filter connected to the second selection terminal; and a third filter. The second switch is connected in series to and between the third filter and a path connecting the second selection terminal and the second filter, and the third filter has a pass band including a supplementary downlink (SDL) band.

A communication apparatus according to an aspect of the present disclosure includes the radio frequency circuit according to the aspect above and a radio frequency (RF) signal processing circuit that processes a radio frequency signal transmitted through the radio frequency circuit.

### Advantageous Effects of Disclosure

According to the present disclosure, loss may be reduced.

### BRIEF DESCRIPTION OF DRAWINGS

FIG. 1 is a circuit configuration diagram of a radio frequency circuit and a communication apparatus according to Embodiment 1.

FIG. 2 is a circuit configuration diagram of a radio frequency circuit according to a comparative example.

FIG. 3 is a circuit configuration diagram of a radio frequency circuit according to Modification 1 of Embodiment 1.

FIG. 4 is a circuit configuration diagram of a radio frequency circuit according to Modification 2 of Embodiment 1.

FIG. 5 is a circuit configuration diagram of a radio frequency circuit according to Modification 3 of Embodiment 1.

FIG. 6 is a circuit configuration diagram of a radio frequency circuit and a communication apparatus according to Embodiment 2.

FIG. 7 is a circuit configuration diagram of a radio frequency circuit according to a modification of Embodiment 2.

FIG. 8 is a circuit configuration diagram of a radio frequency circuit according to Embodiment 3.

FIG. 9 is a circuit configuration diagram of a radio frequency circuit according to a modification of Embodiment 3.

### DESCRIPTION OF EMBODIMENTS

Hereinafter, a radio frequency circuit and a communication apparatus according to embodiments of the present disclosure will be described in detail by using the drawings. The embodiments described below each illustrate a specific example of the present disclosure. Accordingly, a numerical value, a shape, a material, a component, the layout and connection form of the component, a step, the order of steps, and the like described in the following embodiments are an example and are not intended to limit the present disclosure. Among components in the following embodiments, a component that is not described in an independent claim is thus described as an optional component.

The drawings are schematic drawings and thus are not necessarily illustrated precisely. Accordingly, for example, reduced scales or the like in the respective drawings do not necessarily correspond to each other. Substantially the same components in the drawings are denoted by the same reference numerals, and overlapping explanation is omitted or simplified.

In this specification, the term “connected” includes not only “directly connected” by using a connection terminal and/or a wiring conductor but also “electrically connected with another circuit element interposed between one circuit element and the other circuit element”. In addition, the phrase “connected between A and B” denotes that a component is connected between A and B and to both of A and B.

In this specification, ordinal numerals such as “first” and “second” do not mean the number of components or the order of the components and are used to avoid confusion of the same types of components and to discriminate therebetween, otherwise particularly stated.

In this specification, the term “sending path” denotes a transmission line composed of a wiring line through which a radio frequency sending signal is transmitted, an electrode directly connected to the wiring line, a terminal directly connected to the wiring line or the electrode, and other components. The term “reception path” denotes a transmission line composed of a wiring line through which a radio frequency reception signal is transmitted, an electrode directly connected to the wiring line, a terminal directly connected to the wiring line or the electrode, and other components. The term “sending and reception path” denotes a transmission line composed of a wiring line through which both of a radio frequency sending signal and a radio frequency reception signal are transmitted, an electrode directly connected to the wiring line, a terminal directly connected to the wiring line or the electrode, and other components.

### Embodiment 1

### [1.1 Circuit Configuration of Radio Frequency Circuit 1 and Communication Apparatus 4]

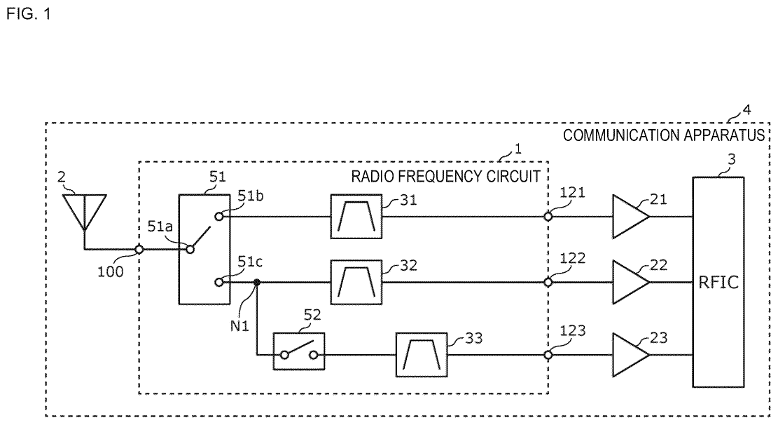

First, the circuit configuration of a radio frequency circuit 1 and a communication apparatus 4 according to Embodiment 1 will be described by using FIG. 1. FIG. 1 is a circuit configuration diagram of the radio frequency circuit 1 and the communication apparatus 4 according to this embodiment.

### [1.1.1 Circuit Configuration of Communication Apparatus 4]

First, the circuit configuration of the communication apparatus 4 will be described. The communication apparatus 4 illustrated in FIG. 1 is an apparatus used in a communication system and is a mobile terminal such as a smartphone or a tablet computer. As illustrated in FIG. 1, the communication apparatus 4 according to this embodiment includes the radio frequency circuit 1, an antenna 2, and a RF signal processing circuit (RFIC) 3. The communication apparatus 4 also includes a plurality of low-noise amplifiers 21, 22, and 23.

The radio frequency circuit 1 transmits a radio frequency signal between the antenna 2 and the RFIC 3. In this embodiment, the radio frequency circuit 1 transmits a reception signal that is an example of the radio frequency signal. The radio frequency circuit 1 may transmit a sending signal that is an example of the radio frequency signal. The detailed configuration of the radio frequency circuit 1 will be described later.

The antenna 2 is connected to an antenna connection terminal 100 of the radio frequency circuit 1. The antenna 2 receives a radio frequency signal from an outside and outputs a radio frequency signal to the radio frequency circuit 1. The antenna 2 may send a radio frequency signal output from the radio frequency circuit 1.

The RFIC 3 is an example of a signal processing circuit that processes a radio frequency signal. Specifically, the RFIC 3 performs signal processing of a radio frequency reception signal input through a reception path of the radio frequency circuit 1 by downconverting or the like and outputs a reception signal generated by the signal processing to a base band signal processing circuit (BBIC, not illustrated). The RFIC 3 may also perform signal processing of a sending signal input from the BBIC, by upconverting or the like and output a radio frequency sending signal generated by the signal processing to a sending path of the radio frequency circuit 1. The RFIC 3 also has a controller that controls switches, amplifiers, and other components of the radio frequency circuit 1. Part or all of functions as the controller of the RFIC 3 may be mounted on the outside of the RFIC 3 and may be mounted, for example, on the BBIC or the radio frequency circuit 1.

Each of the low-noise amplifiers 21, 22, and 23 is an example of an amplifier that amplifies a radio frequency signal. Each of the low-noise amplifiers 21, 22, and 23 amplifies a reception signal transmitted through the radio frequency circuit 1. The low-noise amplifier 21 is connected to a radio frequency output terminal 121 of the radio frequency circuit 1 and amplifies a reception signal output from the radio frequency output terminal 121. The low-noise amplifier 22 is connected to a radio frequency output terminal 122 of the radio frequency circuit 1 and amplifies a reception signal output from the radio frequency output terminal 122. The low-noise amplifier 23 is connected to a radio frequency output terminal 123 of the radio frequency circuit 1 and amplifies a reception signal output from the radio frequency output terminal 123. The low-noise amplifiers 21, 22, and 23 amplify reception signals in respective different communication bands. The low-noise amplifiers 21, 22, and 23 may be formed as modules mounted on the same substrate as for the radio frequency circuit 1.

The circuit configuration of the communication apparatus 4 illustrated in FIG. 1 is an example and is not limited to this. For example, the communication apparatus 4 does not have to include the antenna 2. Alternatively, the communication apparatus 4 may include a plurality of antennas 2.

The communication apparatus 4 does not have to include the low-noise amplifiers 21, 22, and 23. For example, the communication apparatus 4 may include one low-noise amplifier that amplifies reception signals in a plurality of communication bands.

### [1.1.2 Circuit Configuration of Radio Frequency Circuit 1]

The circuit configuration of the radio frequency circuit 1 according to this embodiment will then be described.

As illustrated in FIG. 1, the radio frequency circuit 1 includes filters 31, 32, and 33, switches 51 and 52, the antenna connection terminal 100, the radio frequency output terminals 121, 122, and 123.

The antenna connection terminal 100 is connected to the antenna 2.

The radio frequency output terminal 121 is connected to the RFIC 3 with the low-noise amplifier 21 interposed therebetween. The radio frequency output terminal 121 is a terminal for outputting, to the low-noise amplifier 21, a reception signal received by the antenna 2 and transmitted through the radio frequency circuit 1.

The radio frequency output terminal 122 is connected to the RFIC 3 with the low-noise amplifier 22 interposed therebetween. The radio frequency output terminal 122 is a terminal for outputting, to the low-noise amplifier 22, a reception signal received by the antenna 2 and transmitted through the radio frequency circuit 1.

The radio frequency output terminal 123 is connected to the RFIC 3 with the low-noise amplifier 23 interposed therebetween. The radio frequency output terminal 123 is a terminal for outputting, to the low-noise amplifier 23, a reception signal received by the antenna 2 and transmitted through the radio frequency circuit 1.

The filters 31, 32, and 33 are each a reception filter having a pass band including at least part of a predetermined communication band. The respective pass bands of the filters 31, 32, and 33 are different from each other.

The communication band denotes a frequency band defined in advance, for a communication system built up by using, for example, radio access technology (RAT: radio access technology), by a standardization organization or the like (such as 3rd Generation Partnership Project (3GPP (registered trademark)) or Institute of Electrical and Electronics Engineers (IEEE)). In this embodiment, for example, a 4th Generation-Long Term Evolution (4G-LTE) system, a 5th Generation-New Radio (5G-NR) system, a wireless local area network (WLAN) system, and the like are usable as the communication system, but the communication system is not limited to these.

The filter 31 is an example of a first filter and has a pass band including a first band. The input terminal of the filter 31 is connected to a selection terminal 51b of the switch 51. To a path connecting the filter 31 and the selection terminal 51b therebetween, a switch is not connected in series. The output terminal of the filter 31 is connected to the radio frequency output terminal 121.

The first band is, for example, a downlink operating band (2110-2170 MHz) in Band B1 for LTE or a downlink operating band (2110-2170 MHz) in Band n1 for 5G-NR.

The filter 32 is an example of a second filter and has a pass band including a second band. The input terminal of the filter 32 is connected to a selection terminal 51c of the switch 51. To a path connecting the filter 32 and the selection terminal 51c therebetween, a switch is not connected in series. The output terminal of the filter 32 is connected to the radio frequency output terminal 122.

The second band is a band different from the first band. The second band is, for example, a downlink operating band (1805-1880 MHz) in Band B3 for LTE or a downlink operating band (1805-1880 MHz) in Band n3 for 5G-NR.

The filter 33 is an example of a third filter and has a pass band including a third band. The input terminal of the filter 33 is connected to the selection terminal 51c of the switch 51 with the switch 52 interposed therebetween. The output terminal of the filter 33 is connected to the radio frequency output terminal 123.

The third band is a band different from any of the first band and the second band. For example, the third band is a band that does not overlap with the second band. In this embodiment, the third band is a supplementary downlink (SDL) band. The third band is, for example, Band B32 (1452-1496 MHz) for LTE or one of Band n75 (1432-1517 MHz) and Band n76 (1427-1432 MHz) that are for 5G-NR.

The switch 51 is an example of a first switch and has a common terminal 51a and the selection terminals 51b and 51c. The switch 51 performs switching between connection (conduction) and non-connection (non-conduction) of the common terminal 51a to one of the selection terminals 51b and 51c. The common terminal 51a is connected to the antenna connection terminal 100. The selection terminal 51b is an example of a first selection terminal and is connected to the filter 31. The selection terminal 51c is an example of a second selection terminal and is connected to each of the filter 32 and the switch 52. The switch 51 is also called an antenna switch. The switch 51 is a switch circuit of a single-pole double-throw (SPDT) type. The switch 51 may also be a multi-connection switch circuit. The common terminal 51a may thus be connected to both of the selection terminals 51b and 51c at a time.

The switch 52 is an example of a second switch. The switch 52 is connected in series to and between the filter 33 and the path connecting the selection terminal 51c of the switch 51 and the filter 32. Specifically, the switch 52 is connected in series to and between the filter 33 and a node N1 located on the path connecting the selection terminal 51c and the filter 32. The node N1 may correspond to the selection terminal 51c or the input terminal of the filter 32. The switch 52 is capable of switching between connection and non-connection of the selection terminal 51c (node N1) to the filter 33. The switch 52 is a switch circuit of a single-pole single-throw (SPST) type.

### 1.2 Operations

The operations of the radio frequency circuit 1 according to this embodiment will then be described with reference to FIG. 1.

The radio frequency circuit 1 has a single transmission mode and a simultaneous transmission mode.

In the single transmission mode, a radio frequency signal in one communication band is transmitted. Specifically, in the single transmission mode, only one of the filters 31 and 32 operates under the control of the switches 51 and 52. The phrase “a filter operates” denotes that the filter becomes in a state where a radio frequency signal in the pass band of the filter is transmittable. The switches 51 and 52 are run by an unillustrated controller.

For example, connecting the common terminal 51a of the switch 51 to the selection terminal 51b causes only the filter 31 to operate. In addition, connecting the common terminal 51a of the switch 51 to the selection terminal 51c and preventing the switch 52 from conducting (an open state) cause only the filter 32 to operate.

In this embodiment, the filter 33 is a filter having a pass band including the SDL band and is a filter operating in an auxiliary manner. Accordingly, the filter 33 does not operate alone. That is, the single transmission for only a signal passing through the filter 33 is not performed. A signal passing through the filter 33 is transmitted simultaneously with a signal passing through the filter 32. The filter 33 is thus an auxiliary filter for the filter 32. In other words, the filter 33 is a filter that is used as an auxiliary for the filter 32 and that does not operate alone.

In the simultaneous transmission mode, radio frequency signals in a plurality of communication bands are transmitted. Specifically, in the simultaneous transmission mode, two or more filters of the filters 31, 32, and 33 operate under the control of the switches 51 and 52.

For example, connecting the common terminal 51a of the switch 51 to the selection terminal 51c and allowing the switch 52 to conduct (in a closed state) causes two of the filters 32 and 33 to operate. Assuming the switch 51 is a multi-connection switch circuit, the common terminal 51a is connectable to both of the selection terminals 51b and 51c. For example, connecting the common terminal 51a of the switch 51 to each of the selection terminals 51b and 51c and preventing the switch 52 from conducting cause two of the filters 31 and 32 to operate. Connecting the common terminal 51a of the switch 51 to each of the selection terminals 51b and 51c and allowing the switch 52 to conduct cause the three filters 31, 32, and 33 to operate.

### 1.3 Advantageous Effects and the Like

Subsequently, advantageous effects and the like of the radio frequency circuit 1 according to this embodiment will be described as compared with a comparative example.

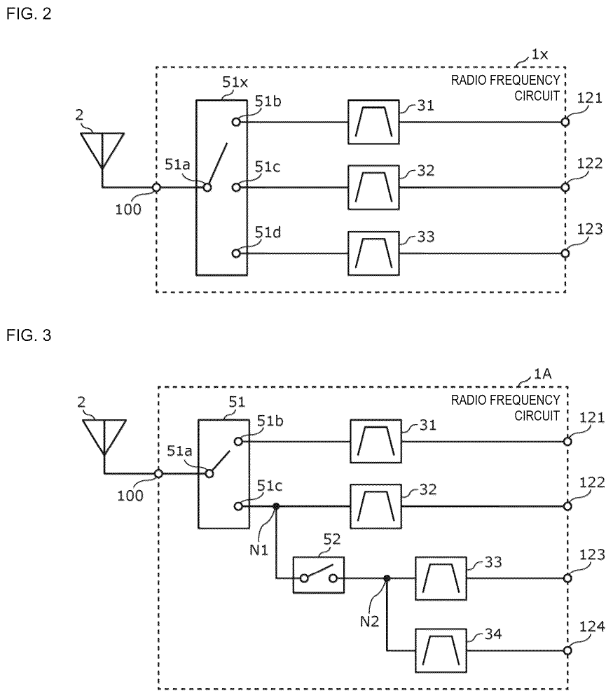

FIG. 2 is a circuit configuration diagram of a radio frequency circuit 1x according to the comparative example. As illustrated in FIG. 2, as compared with the radio frequency circuit 1 according to this embodiment, the radio frequency circuit 1x according to the comparative example includes a switch 51x instead of the switches 51 and 52.

The switch 51x has the common terminal 51a, the selection terminals 51b and 51c, and a selection terminal 51d. The switch 51x performs switching between connection and non-connection of the common terminal 51a to one of the selection terminals 51b, 51c, and 51d. The common terminal 51a and the selection terminals 51b and 51c are respectively connected to the antenna connection terminal 100, the input terminal of the filter 31, and the input terminal of the filter 32, like the switch 51 of the radio frequency circuit 1. The selection terminal 51d is connected to the input terminal of the filter 33. That is, in the radio frequency circuit 1x according to the comparative example, the input terminal of the filter 33 is directly connected to the selection terminal 51d of the switch 51x without the switch 52 interposed therebetween.

The switch 51x is a multi-connection switch circuit. The common terminal 51a is thus connectable to one or more or two or more of the selection terminals 51b, 51c, and 51d. Also in the radio frequency circuit 1x according to the comparative example like the radio frequency circuit 1 according to the embodiment, this enables operations in the single transmission mode and the simultaneous transmission mode described above by controlling the switch 51x.

Assume a case where the filter 31 operates in the single transmission mode. In this case, in the radio frequency circuit 1x according to the comparative example, the common terminal 51a of the switch 51x is not connected to any of the selection terminals 51c and 51d. Accordingly, off-state capacitances are formed between the common terminal 51a and the selection terminal 51c and between the common terminal 51a and the selection terminal 51d. Since it is seen that the two off-state capacitances are connected parallel to the common terminal 51a, a signal leaks to each of the filters 32 and 33, and thus loss is increased.

In contrast, in the radio frequency circuit 1 according to this embodiment, assuming the filter 31 operates, a selection terminal without the common terminal 51a connected thereto is only the selection terminal 51c. In other words, the switch 51 in the radio frequency circuit 1 has less selection terminals than those in the radio frequency circuit 1x according to the comparative example. The filter 33 is connected to the selection terminal 51c with the switch 52 interposed therebetween. The switch 52 is thus connected in series to and between the filter 33 and the path connecting the selection terminal 51c and the filter 32. Accordingly, assuming the filter 31 operates, regarding the common terminal 51a, only the off-state capacitance attributed to the selection terminal 51c is seen, and the off-state capacitance of the switch 52 for preventing the filter 33 from operating is not seen. Accordingly, the number of signals leaking to the filters 32 and 33 may be reduced, and thus loss may be reduced.

As described above, the radio frequency circuit 1 according to this embodiment includes the switch 51 having the selection terminals 51b and 51c, the switch 52, the filter 31 connected to the selection terminal 51b, the filter 32 connected to the selection terminal 51c, and the filter 33. The switch 52 is connected in series to and between the filter 33 and the path connecting the selection terminal 51c and the filter 32.

As described above, the filter 33 is connected to the selection terminal 51c with the switch 52 interposed therebetween. Accordingly, assuming only the filter 31 operates, the off-state capacitance of the switch 52 is not seen. Accordingly, the number of signals leaking to the filters 32 and 33 may be reduced, and thus loss may be reduced.

In addition, for example, the filter 33 has the pass band including the SDL band.

The filter 33 has thus a band dedicated to a downlink and does not have an uplink operating band therefor. Accordingly, an uplink operating band attenuation requirement to be close does not have to be satisfied, and thus filter designing may be simplified. The filter 33 may thus be downsized, and the downsizing may contribute to the downsizing of the radio frequency circuit 1.

In addition, for example, the single transmission for only a signal passing through the filter 33 is not performed.

Accordingly, the filter 33 is not used for the single transmission mode, a selection terminal (for example, the selection terminal 51d in FIG. 2) for exclusively connecting the filter 33 to the switch 51 does not have to be provided.

Accordingly, off-state capacitance in the case of not operating the filter 33 may be reduced, and thus loss may be reduced.

In addition, for example, the switch 51 has the common terminal 51a and is capable of performing switching between connection between the common terminal 51a and the selection terminal 51b and connection between the common terminal 51a and the selection terminal 51c. The switch 52 is configured to conduct at the time of the connection between the common terminal 51a and the selection terminal 51c. A signal passing through the filter 33 is thus transmittable simultaneously with a signal passing through the filter 32.

This enables the filter 32 and the filter 33 to be connected to the same selection terminal 51c, and thus the number of selection terminals of the switch 51 may be reduced. Accordingly, the off-state capacitance in the case of not operating the filter 33 may be reduced, and thus loss may be reduced.

The communication band included in the pass band of each of the filters 31, 32, and 33 is not limited to the example described above. The communication band may be appropriately adjusted according to specifications required for the radio frequency circuit 1.

In addition, for example, the communication apparatus 4 according to this embodiment includes the radio frequency circuit 1 and the RFIC 3 that processes a radio frequency signal transmitted through the radio frequency circuit 1.

In the case where the filter 31 operates, the inclusion of the radio frequency circuit 1 thereby enables the number of signals leaking to the filters 32 and 33 to be reduced and thus enables loss to be reduced.

### 1.4 Modifications

Subsequently, a modifications of Embodiment 1 will be described. The description is provided below, focusing on differences from Embodiment 1, and the description of points in common is omitted or simplified.

### 1.4.1 Modification 1

FIG. 3 is a circuit configuration diagram of a radio frequency circuit 1A according to Modification 1 of this embodiment. As illustrated in FIG. 3, the radio frequency circuit 1A further includes a filter 34 and a radio frequency output terminal 124, as compared with the radio frequency circuit 1 illustrated in FIG. 1.

The radio frequency output terminal 124 is connected to the RFIC 3 (see FIG. 1) with, for example, an unillustrated low-noise amplifier interposed therebetween. The radio frequency output terminal 124 is a terminal for outputting, to the low-noise amplifier (not illustrated), a reception signal received by the antenna 2 and transmitted through the radio frequency circuit 1A.

The filter 34 is an example of a fourth filter and has a pass band including a fourth band. The input terminal of the filter 34 is connected to a path connecting the switch 52 and the filter 33. Specifically, the input terminal of the filter 34 is connected to a node N2 located on the path connecting the switch 52 and the filter 33. The node N2 may correspond to one end of the switch 52 (a terminal on the filter 33 side) or the input terminal of the filter 33. The output terminal of the filter 34 is connected to the radio frequency output terminal 124.

The fourth band is a band different from any of the first band, the second band, and the third band. For example, the fourth band is a band that does not overlap with any of the second band and the third band. As the third band and the fourth band, bands not involving attenuation requirements close to each other, that is, bands with low degree of designing difficulty are usable.

In this embodiment, each of the second band, the third band, and the fourth band is a time division duplex (TDD) band. The second band is, for example, Band B41 (2496-2690 MHz) for LTE or Band n41 (2496-2690 MHz) for 5G-NR. The third band is, for example, Band B34 (2010-2025 MHz) for LTE or Band n34 (2010-2025 MHz) for 5G-NR. The fourth band is, for example, Band B39 (1880-1920 MHz) for LTE or Band n39 (1880-1920 MHz) for 5G-NR.

In this modification, in the single transmission mode, only one of the filters 33 and 34 may operate. In other words, the filters 33 and 34 may each operate alone. For example, connecting the common terminal 51a of the switch 51 to the selection terminal 51c and allowing the switch 52 to conduct cause the filters 32, 33, and 34 to be in an operable state. The filters 32, 33, and 34 are TDD filters and thus are operable alone (in the single transmission mode). Alternatively, at least two of the filters 32, 33, and 34 are simultaneously operable (in the simultaneous transmission mode).

As described above, the radio frequency circuit 1A according to this modification further includes the filter 34 having the one end connected to the path connecting the switch 52 and the filter 33.

Assuming only the filter 31 operates, this causes the off-state capacitance of the switch 52 not to be seen because the filters 33 and 34 are connected to the selection terminal 51c with the switch 52 interposed therebetween, like the radio frequency circuit 1 according to Embodiment 1. Accordingly, the number of signals leaking to the filters 32, 33, and 34 may be reduced, and thus loss may be reduced. In addition, the increase of the number of filters of the radio frequency circuit 1A enables the types (communication bands) of transmittable signals to be increased.

### 1.4.2 Modification 2

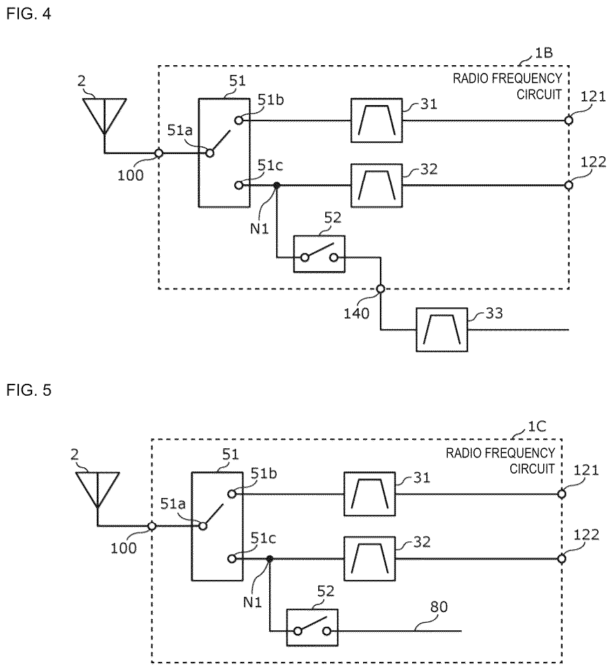

FIG. 4 is a circuit configuration diagram of a radio frequency circuit 1B according to Modification 2 of this embodiment. As illustrated in FIG. 4, as compared with the radio frequency circuit 1 illustrated in FIG. 1, the radio frequency circuit 1B does not include the filter 33 and the radio frequency output terminal 123 but includes an external connection terminal 140.

The external connection terminal 140 is a radio frequency output terminal of the radio frequency circuit 1B and is a terminal for outputting a reception signal received by the antenna 2 to the outside. For example, assuming the radio frequency circuit 1B is formed as a module on the substrate, the external connection terminal 140 is formed by using a conductive member such as a bump electrode or a land provided on the surface of the substrate.

As illustrated in FIG. 4, the switch 52 is connected in series to and between the external connection terminal 140 and the path connecting the selection terminal 51c of the switch 51 and the filter 32. Specifically, the switch 52 is connected in series to and between the node N1 and the external connection terminal 140. More specifically, the filter 33 is neither connected between the selection terminal 51c of the switch 51 and the switch 52 nor between the switch 52 and the external connection terminal 140. The filter 33 is connected to the external connection terminal 140 outside the radio frequency circuit 1B.

As described above, the radio frequency circuit 1B according to this modification includes the switch 51 having the selection terminals 51b and 51c, the switch 52, the filter 31 connected to the selection terminal 51b, the filter 32 connected to the selection terminal 51c, and the external connection terminal 140. The switch 52 is connected in series to and between the external connection terminal 140 and the path connecting the selection terminal 51c and the filter 32.

Assuming the filter 31 operates, this causes the off-state capacitance of the switch 52 not to be seen because the external connection terminal 140 for connecting the filter 33 is connected to the selection terminal 51c with the switch 52 interposed therebetween, like the radio frequency circuit 1 according to Embodiment 1. Accordingly, the number of signals leaking to the filter 32 and the external connection terminal 140 may be reduced, and thus loss may be reduced. In addition, since the filter 33 is attachable to the radio frequency circuit 1B externally, replacement of the filter 33 having properties varying with the requirement is performed easily.

In this modification, the band included in the pass band of each of the filters 31, 32, and 33 is the same as that of the radio frequency circuit 1 according to Embodiment 1. For example, the first band of the filter 31 is the downlink operating band in Band B1 or Band n1. The second band of the filter 32 is the downlink operating band in Band B3 or Band n3. The third band of the filter 33 is Band B32, Band n75, or Band n76. These are merely an example. At least one of the filters 31, 32, and 33 may be a TDD band, like Modification 1.

To the external connection terminal 140, a low-noise amplifier may also be connected, instead of the filter 33.

### 1.4.3 Modification 3

FIG. 5 is a circuit configuration diagram of a radio frequency circuit 1C according to Modification 3 of this embodiment. As illustrated in FIG. 5, as compared with the radio frequency circuit 1 illustrated in FIG. 1, the radio frequency circuit 1C does not include the filter 33 and the radio frequency output terminal 123 but includes a stub 80.

The stub 80 is wiring of a predetermined line length. For example, the line length of the stub 80 is longer than or equal to one-fourth of the wavelength of the radio frequency signal. The stub 80 is an open stub. One end thereof is connected to the switch 52, and the other end is open.

As illustrated in FIG. 5, the switch 52 is connected in series to and between the stub 80 and the path connecting the selection terminal 51c of the switch 51 and the filter 32. Specifically, the switch 52 is connected in series to and between the node N1 and the stub 80. More specifically, a filter is not connected between the switch 52 and the stub 80. A filter is not connected to the other end of the stub 80 (an end portion opposite from the switch 52).

The radio frequency circuit 1C according to this modification has the single transmission mode and the simultaneous transmission mode, like the radio frequency circuit 1 according to Embodiment 1. In this case, impedance seen from the common terminal 51a of the switch 51 toward a filter differs between assuming only the filter 31 is operated (single transmission mode) and assuming both of the filters 31 and 32 are operated (simultaneous transmission mode). In this case, the impedance may be adjusted by using the stub 80 by switching between the conduction and non-conduction of the switch 52.

For example, the impedance is adjusted in advance such that the impedance matching is achievable in a state where the switch 52 does not conduct assuming only the filter 31 is operated. In this case, to operate the filters 31 and 32 simultaneously, allowing the switch 52 to conduct enables impedance mismatch at the simultaneous transmission to be controlled. Alternatively, the impedance may be adjusted in advance such that impedance matching is achievable in a state where the switch 52 does not conduct assuming the filters 31 and 32 are simultaneously operated. In this case, to operate only the filter 31, allowing the switch 52 to conduct enables impedance mismatch at the single transmission to be controlled.

As described above, the radio frequency circuit 1C according to this embodiment example includes the switch 51 having the selection terminals 51b and 51c, the switch 52, the filter 31 connected to the selection terminal 51b, the filter 32 connected to the selection terminal 51c, and the stub 80. The switch 52 is connected in series to and between the stub 80 and the path connecting the selection terminal 51c and the filter 32.

The impedance may thereby be adjusted by using the stub 80, and thus loss may be reduced.

Adjusting a line length may cause the stub 80 to function as a notch filter having a narrow stopband for a predetermined frequency. The stub 80 may be a shorted stub having the other end connected to the ground.

### Embodiment 2

Subsequently, Embodiment 2 will be described.

As compared with Embodiment 1, a radio frequency circuit according to Embodiment 2 is different in a point that the radio frequency circuit includes a sending filter. The description is provided below, focusing on differences from Embodiment 1, and the description of points in common is omitted or simplified.

### 2.1 Circuit Configuration of Radio Frequency Circuit 201 and Communication Apparatus 204

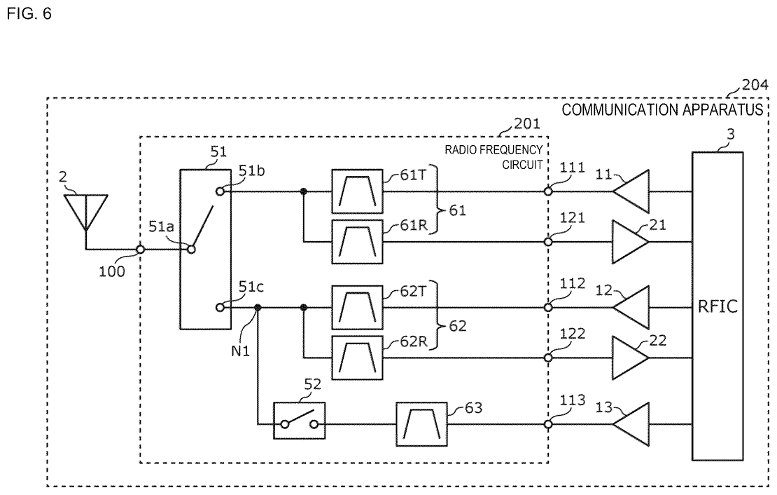

First, the circuit configuration of a radio frequency circuit 201 and a communication apparatus 204 according to Embodiment 2 will be described by using FIG. 6. FIG. 6 is a circuit configuration diagram of the radio frequency circuit 201 according to this embodiment and the communication apparatus 204.

### 2.1.1 Circuit Configuration of Communication Apparatus 204

First, the configuration of the communication apparatus 204 will be described. As illustrated in FIG. 6, the communication apparatus 204 according to this embodiment includes the radio frequency circuit 201, the antenna 2, and the RF signal processing circuit (RFIC) 3. The communication apparatus 204 also includes a plurality of power amplifiers 11, 12, and 13 and a plurality of low-noise amplifiers 21 and 22. The antenna 2, the RFIC 3, and the low-noise amplifiers 21 and 22 are the same as those in Embodiment 1.

The radio frequency circuit 201 transmits a radio frequency signal between the antenna 2 and the RFIC 3. In this embodiment, the radio frequency circuit 201 transmits a reception signal that is an example of the radio frequency signal. The radio frequency circuit 201 also transmits a sending signal that is an example of the radio frequency signal. The detailed configuration of the radio frequency circuit 201 will be described later.

The power amplifiers 11, 12, and 13 are each an example of the amplifier that amplifies a radio frequency signal. The power amplifiers 11, 12, and 13 each amplify a sending signal and outputs the amplified signal to the radio frequency circuit 201. The power amplifier 11 is connected to a radio frequency input terminal 111 of the radio frequency circuit 201, amplifies a sending signal, and inputs the amplified sending signal to the radio frequency input terminal 111. The power amplifier 12 is connected to a radio frequency input terminal 112 of the radio frequency circuit 201, amplifies a sending signal, and inputs the amplified sending signal to the radio frequency input terminal 112. The power amplifier 13 is connected to a radio frequency input terminal 113 of the radio frequency circuit 201, amplifies a sending signal, and inputs the amplified sending signal to the radio frequency input terminal 113. The power amplifiers 11, 12, and 13 amplify sending signals in respective different communication bands. The power amplifiers 11, 12, and 13 may be formed as modules mounted on the same substrate as for the radio frequency circuit 201.

The circuit configuration of the communication apparatus 204 illustrated in FIG. 6 is an example and is not limited to this. For example, the communication apparatus 204 does not have to include the antenna 2. Alternatively, the communication apparatus 204 may include the plurality of antennas 2.

In addition, the communication apparatus 204 does not have to include the power amplifiers 11, 12, and 13 and the low-noise amplifiers 21 and 22. For example, the communication apparatus 204 may include one low-noise amplifier that amplifies reception signals in a plurality of communication bands. The communication apparatus 204 may also include one power amplifier that amplifies sending signals in a plurality of communication bands.

### 2.1.2 Circuit Configuration of Radio Frequency Circuit 201

The circuit configuration of the radio frequency circuit 201 according to this embodiment will then be described.

As illustrated in FIG. 6, the radio frequency circuit 201 includes duplexers 61 and 62, a filter 63, the switches 51 and 52, the antenna connection terminal 100, the radio frequency input terminals 111, 112, and 113, and the radio frequency output terminals 121 and 122. The antenna connection terminal 100, the radio frequency output terminals 121 and 122, and the switches 51 and 52 are the same as those in Embodiment 1.

The radio frequency input terminal 111 is connected to the RFIC 3 with the power amplifier 11 interposed therebetween. The radio frequency input terminal 111 is a terminal for receiving input of a sending signal amplified by the power amplifier 11.

The radio frequency input terminal 112 is connected to the RFIC 3 with the power amplifier 12 interposed therebetween. The radio frequency input terminal 112 is a terminal for receiving input of a sending signal amplified by the power amplifier 12.

The radio frequency input terminal 113 is connected to the RFIC 3 with the power amplifier 13 interposed therebetween. The radio frequency input terminal 113 is a terminal for receiving input of a sending signal amplified by the power amplifier 13.

The duplexers 61 and 62 are each an element that demultiplexes a sending signal and a reception signal. The pass bands of the filters of each of the duplexers 61 and 62 are different from each other.

The duplexer 61 has a reception filter 61R and a sending filter 61T.

The reception filter 61R is an example of the first filter and has a pass band including a first downlink operating band. The input terminal of the reception filter 61R is connected to the selection terminal 51b of the switch 51. The output terminal of the reception filter 61R is connected to the radio frequency output terminal 121.

The sending filter 61T is an example of a first sending filter and has a pass band including a first uplink operating band. The input terminal of the sending filter 61T is connected to the radio frequency input terminal 111. The output terminal of the sending filter 61T is connected to the selection terminal 51b of the switch 51. In this embodiment, the output terminal of the sending filter 61T and the input terminal of the reception filter 61R are shared (bundled) and connected to the selection terminal 51b. To a path connecting each of the input terminal of the reception filter 61R and the output terminal of the sending filter 61T (the common terminal of the duplexer 61) and the selection terminal 51b therebetween, a switch is not connected in series.

The first downlink operating band is, for example, the downlink operating band (2110-2170 MHz) in Band B1 or Band n1. The first uplink operating band is, for example, an uplink operating band (1920-1980 MHz) in Band B1 or Band n1. The first downlink operating band and the first uplink operating band may be included in different communication bands.

The duplexer 62 has a reception filter 62R and a sending filter 62T.

The reception filter 62R is an example of the second filter and has a pass band including a second downlink operating band. The input terminal of the reception filter 62R is connected to the selection terminal 51c of the switch 51. The output terminal of the reception filter 62R is connected to the radio frequency output terminal 122.

The sending filter 62T is an example of a second sending filter and has a pass band including a second uplink operating band. The input terminal of the sending filter 62T is connected to the radio frequency input terminal 112. The output terminal of the sending filter 62T is connected to the selection terminal 51c of the switch 51. In this embodiment, the output terminal of the sending filter 62T and the input terminal of the reception filter 62R are shared (bundled) and connected to the selection terminal 51c. To a path connecting each of the input terminal of the reception filter 62R and the output terminal of the sending filter 62T (the common terminal of the duplexer 62) and the selection terminal 51c therebetween, a switch is not connected in series.

The second downlink operating band is a band different from the first downlink operating band. The second downlink operating band is, for example, the downlink operating band (1805-1880 MHz) in Band B3 or Band n3. The second uplink operating band is a band different from the first uplink operating band. The second uplink operating band is, for example, an uplink operating band (1710-1785 MHz) in Band B3 or Band n3. The second downlink operating band and the second uplink operating band may be included in different communication bands.

The filter 63 is an example of the third filter and has a pass band including the third band. The input terminal of the filter 63 is connected to the radio frequency input terminal 113. The output terminal of the filter 63 is connected to the selection terminal 51c of the switch 51 with the switch 52 interposed therebetween.

The third band included in the pass band of the filter 63 is a band different from any of the first uplink operating band and the second uplink operating band. For example, the third band is a band that does not overlap with the second uplink operating band. In this embodiment, the third band is a supplementary uplink (SUL) band. The third band is one of, for example, Band n81 for 5G-NR (880-915 MHz), Band n82 (832-862 MHz), Band n83 (703-748 MHz), and Band n89 (824-849 MHz).

### 2.2 Operations

The operations of the radio frequency circuit 201 according to this embodiment will then be described with reference to FIG. 6.

The radio frequency circuit 201 has the single transmission mode and the simultaneous transmission mode.

In the single transmission mode, a radio frequency signal in one communication band is transmitted. Specifically, in the single transmission mode, only one of the reception filter 61R, the sending filter 61T, the reception filter 62R, and the sending filter 62T operates under the control of the switches 51 and 52.

For example, connecting the common terminal 51a of the switch 51 to the selection terminal 51b causes the reception filter 61R or the sending filter 61T to operate. In addition, connecting the common terminal 51a of the switch 51 to the selection terminal 51c and preventing the switch 52 from conducting (open state) cause the reception filter 62R or the sending filter 62T to operate.

In this embodiment, the filter 63 is a filter having a pass band including the SUL band and is a filter operating in an auxiliary manner. Accordingly, the filter 63 does not operate alone. That is, the single transmission for only a signal passing through the filter 63 is not performed. The signal passing through the filter 63 is transmitted simultaneously with a signal passing through the sending filter 62T or the reception filter 62R. The filter 63 is thus an auxiliary filter of the sending filter 62T or the reception filter 62R. In other words, the filter 63 is a filter that is used as an auxiliary for the sending filter 62T or the reception filter 62R and that does not operate alone.

In the simultaneous transmission mode, radio frequency signals in a plurality of communication bands are transmitted. Specifically, in the simultaneous transmission mode, two or more filters of the reception filter 61R, the sending filter 61T, the reception filter 62R, the sending filter 62T, and the filter 63 operate under the control of the switches 51 and 52. The radio frequency circuit 201 according to this embodiment is capable of simultaneous receiving, simultaneous sending, and simultaneous sending and receiving in a plurality of communication bands.

For example, connecting the common terminal 51a of the switch 51 to the selection terminal 51b and allowing the switch 52 to conduct (in the closed state) cause two of the sending filter 62T and the filter 63 to operate. Assuming the switch 51 is a multi-connection switch circuit, the common terminal 51a is connectable to both of the selection terminals 51b and 51c. For example, connecting the common terminal 51a of the switch 51 to the selection terminals 51b and 51c and preventing the switch 52 from conducting cause the duplexers 61 and 62 to operate. In addition, connecting the common terminal 51a of the switch 51 to the selection terminals 51b and 51c and allowing the switch 52 to conduct cause the duplexers 61 and 62 and the filter 63 to operate.

### 2.3 Advantageous Effects and the Like

As described above, in the radio frequency circuit 201 according to this embodiment, the reception filter 61R has the pass band including the first downlink operating band. The reception filter 62R has the pass band including the second downlink operating band different from the first downlink operating band. The radio frequency circuit 201 further includes the sending filter 61T that has the one end connected to the selection terminal 51b and that has the pass band including the first uplink operating band and the sending filter 62T that has one end connected to the selection terminal 51c and that has the pass band including the second uplink operating band.

Assuming only the duplexer 61 operates, this causes the off-state capacitance of the switch 52 not to be seen because the filter 63 is connected to the selection terminal 51c with the switch 52 interposed therebetween, like the radio frequency circuit 1 according to Embodiment 1. Accordingly, the number of signals leaking to the duplexer 62 and the filter 63 may be reduced, and thus loss may be reduced. In addition, the radio frequency circuit 201 includes the filter for sending and thus is capable of sending and receiving radio frequency signals.

In addition, for example, the filter 63 has a pass band including the SUL band.

The filter 63 has thereby a band dedicated to an uplink and does not have a downlink operating band therefor. Accordingly, a downlink operating band attenuation requirement to be close does not have to be satisfied, and thus filter designing may be simplified. The filter 63 may thus be downsized, and the downsizing may contribute to the downsizing of the radio frequency circuit 201.

In addition, for example, the single transmission for only a signal passing through the filter 63 is not performed.

Accordingly, the filter 63 is not used for the single transmission mode, a selection terminal (for example, the selection terminal 51d in FIG. 2) for exclusively connecting the filter 63 to the switch 51 does not have to be provided. Accordingly, off-state capacitance in the case of not operating the filter 63 may be reduced, and thus loss may be reduced.

In addition, for example, the signal passing through the filter 63 is transmitted simultaneously with a signal passing through the duplexer 62 (the sending filter 62T).

This enables the duplexer 62 and the filter 63 to be connected to the same the selection terminal 51c, and thus the number of selection terminals of the switch 51 may be reduced. Accordingly, the off-state capacitance in the case of not operating the filter 63 may be reduced, and thus loss may be reduced.

In this embodiment, the communication bands included in the pass bands of the duplexers 61 and 62 are not particularly limited.

### 2.4 Modification

Subsequently, a modification of Embodiment 2 will be described. The description is provided below, focusing on differences from Embodiment 2, and the description of points in common is omitted or simplified.

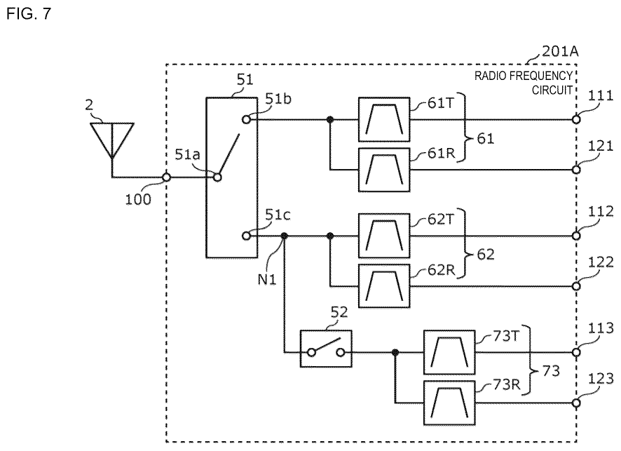

FIG. 7 is a circuit configuration diagram of a radio frequency circuit 201A according to the modification of this embodiment. As illustrated in FIG. 7, as compared with the radio frequency circuit 201 illustrated in FIG. 6, the radio frequency circuit 201A includes a duplexer 73 instead of the filter 63. The radio frequency circuit 201A also includes the radio frequency output terminal 123.

The radio frequency output terminal 123 is connected to the RFIC 3 (see FIG. 6), for example, with an unillustrated low-noise amplifier interposed therebetween. The radio frequency output terminal 123 is a terminal for outputting, to the low-noise amplifier (not illustrated), a reception signal received by the antenna 2 and transmitted through the radio frequency circuit 201A.

The duplexer 73 has a reception filter 73R and a sending filter 73T.

The reception filter 73R is an example of the third filter and has a pass band including a third downlink operating band. The input terminal of the reception filter 73R is connected to the selection terminal 51c of the switch 51 with the switch 52 interposed therebetween. The output terminal of the reception filter 73R is connected to the radio frequency output terminal 123.

The sending filter 73T is an example of a third sending filter and has a pass band including a third uplink operating band. The input terminal of the sending filter 73T is connected to the radio frequency input terminal 113. The output terminal of the sending filter 73T is connected to the selection terminal 51c of the switch 51 with the switch 52 interposed therebetween. In this embodiment, the output terminal of the sending filter 73T and the input terminal of the reception filter 73R are shared (bundled) and connected to the selection terminal 51c with the switch 52 interposed therebetween. To a path connecting each of the input terminal of the reception filter 73R and the output terminal of the sending filter 73T (the common terminal of the duplexer 73) and the switch 52 therebetween, a switch is not connected in series.

The third downlink operating band is a band different from any of the first downlink operating band and the second downlink operating band. The third uplink operating band is a band different from any of the first uplink operating band and the second uplink operating band. For example, the third downlink operating band and the third uplink operating band are bands that do not overlap with each other and that do not overlap with any of the second downlink operating band and the second uplink operating band. As the third downlink operating band and the third uplink operating band, bands not involving attenuation requirements close to each other, that is, bands with low degree of designing difficulty are usable.

In this modification, in the single transmission mode, only one of the reception filter 73R and the sending filter 73T may operate. In other words, the reception filter 73R and the sending filter 73T may each operate alone. For example, connecting the common terminal 51a of the switch 51 to the selection terminal 51c and allowing the switch 52 to conduct cause the duplexer 73 to be in an operable state.

As described above, in the radio frequency circuit 201A according to this modification, the reception filter 73R has the pass band including the third downlink operating band. The radio frequency circuit 201A further includes the sending filter 73T that has the one end connected to the terminal of the switch 52 on the reception filter 73R side and that includes the third uplink operating band.

Assuming only the duplexer 61 operates, this causes the off-state capacitance of the switch 52 not to be seen because the duplexer 73 is connected to the selection terminal 51c with the switch 52 interposed therebetween, like the radio frequency circuit 1 according to Embodiment 1. Accordingly, the number of signals leaking to the duplexers 62 and 73 may be reduced, and thus loss may be reduced. In addition, the increase of the number of duplexers of the radio frequency circuit 201A enables the types (communication bands) of transmittable signals to be increased.

### Embodiment 3

Subsequently, Embodiment 3 will be described.

As compared with Embodiment 1, a radio frequency circuit according to Embodiment 3 is different in a point that an antenna switch has a two-stage configuration. The description is provided below, focusing on differences from Embodiment 1, and the description of points in common is omitted or simplified.

### 3.1 Circuit Configuration of Radio Frequency Circuit 301

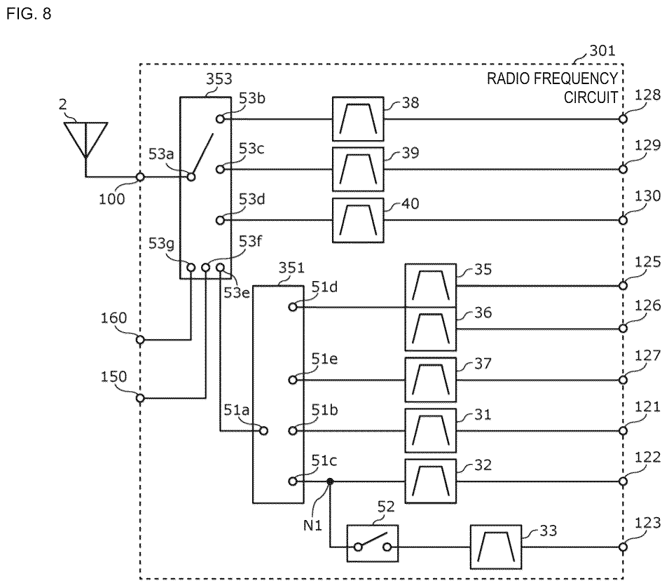

First, the circuit configuration of a radio frequency circuit 301 according to Embodiment 3 will be described by using FIG. 8. FIG. 8 is a circuit configuration diagram of the radio frequency circuit 301 according to this embodiment.

As illustrated in FIG. 8, the radio frequency circuit 301 includes the filters 31, 32, 33, 35, 36, 37, 38, 39, and 40, the switch 52, switches 351 and 353, the antenna connection terminal 100, the radio frequency output terminals 121, 122, and 123, radio frequency output terminals 125, 126, 127, 128, 129, and 130, and external connection terminals 150 and 160. The filters 31, 32, and 33, the antenna connection terminal 100, and the radio frequency output terminals 121, 122, and 123 are the same as those in Embodiment 1.

The radio frequency output terminals 125, 126, 127, 128, 129, and 130 are connected to the RFIC 3 (see FIG. 1) with respective unillustrated low-noise amplifiers interposed therebetween. The radio frequency output terminals 125, 126, 127, 128, 129, and 130 are each a terminal for outputting, to the low-noise amplifier (not illustrated), the reception signal received by the antenna 2 and transmitted through the radio frequency circuit 301.

The external connection terminal 150 is a radio frequency output terminal of the radio frequency circuit 301 and is a terminal for outputting a reception signal received by the antenna 2 to the outside. For example, assuming the radio frequency circuit 301 is formed as a module on the substrate, the external connection terminal 150 is formed by using a conductive member such as a bump electrode or a land provided on the surface of the substrate. The external connection terminal 150 is connected to, for example, a different reception circuit (signal processing circuit) or the like outside the radio frequency circuit 301.

The external connection terminal 160 is a radio frequency input terminal of the radio frequency circuit 301 and is a terminal for receiving, from the outside, a sending signal to be sent from the antenna 2. For example, assuming the radio frequency circuit 301 is formed as a module on the substrate, the external connection terminal 160 is formed by using a conductive member such as a bump electrode or a land provided on the surface of the substrate. The external connection terminal 160 is connected, for example, to a different sending circuit (signal processing circuit) or the like outside the radio frequency circuit 301.

The switches 351 and 353 form an antenna switch in the two-stage configuration. Specifically, a common terminal 53a of the switch 353 is connected to the antenna connection terminal 100, and the common terminal 51a of the switch 351 is connected to one of the selection terminals of the switch 353 (a selection terminal 53e).

The switch 351 is an example of the first switch and has the common terminal 51a, the selection terminals 51b, 51c, and 51d, and a selection terminal 51e. The switch 351 performs switching between connection and non-connection of the common terminal 51a to one of the selection terminals 51b, 51c, 51d, and 51e. The common terminal 51a is connected to the selection terminal 53e of the switch 353. The selection terminal 51b is an example of the first selection terminal and is connected to the filter 31. The selection terminal 51c is an example of the second selection terminal and is connected to each of the filter 32 and the switch 52. The selection terminal 51d is an example of the first selection terminal and is connected to the filters 35 and 36. The selection terminal 51e is an example of the first selection terminal and is connected to the filter 37. The switch 351 is a switch circuit of a single-pole four-throw (SP4T) type. The switch 351 may also be a multi-connection switch circuit. The common terminal 51a may thus be connected to at least two of the selection terminals 51b, 51c, 51d, and 51e at a time.

The switch 353 is an example of a third switch and has the common terminal 53a, selection terminals 53b, 53c, 53d, 53f, and 53g, and the selection terminal 53e. The switch 353 performs switching between connection and non-connection of the common terminal 53a to one of the selection terminals 53b, 53c, 53d, 53e, 53f, and 53g. The common terminal 53a is connected to the antenna connection terminal 100. The selection terminal 53b is an example of a third selection terminal and is connected to the filter 38. The selection terminal 53c is an example of the third selection terminal and is connected to the filter 39. The selection terminal 53d is an example of the third selection terminal and is connected to the filter 40. The selection terminal 53e is an example of a fourth selection terminal and is connected to the common terminal 51a of the switch 351. The selection terminal 53f is connected to the external connection terminal 150. The selection terminal 53g is connected to the external connection terminal 160. The switch 353 is a switch circuit of a single-pole six-throw (SP6T) type. The switch 353 may also be a multi-connection switch circuit. The common terminal 53a may thus be connected to at least two of the selection terminals 53b, 53c, 53d, 53e, 53f, and 53g at a time.

The filters 35, 36, and 37 are each an example of the first filter and has a pass band including at least part of the predetermined communication band. The pass bands of the filters are different from each other.

The filter 35 includes the TDD band in the pass band thereof. The pass band of the filter 35 includes, for example, Band B34 (2010-2025 MHz) for LTE or Band n34 (2010-2025 MHz) for 5G-NR.

The input terminal of the filter 35 is connected to the selection terminal 51d of the switch 351. The output terminal of the filter 35 is connected to the radio frequency output terminal 125.

The filter 36 includes the TDD band in the pass band thereof. The pass band of the filter 36 includes, for example, Band B39 (1880-1920 MHz) for LTE or Band n39 (1880-1920 MHz) for 5G-NR.

The input terminal of the filter 36 is connected to the selection terminal 51d of the switch 351. The output terminal of the filter 36 is connected to the radio frequency output terminal 126. The filter 36 forms a diplexer together with the filter 35. The input terminal of the filter 36 and the input terminal of the filter 35 are thus shared (bundled) and are connected to the selection terminal 51d of the switch 351. The switch 351 may have respective selection terminals for the filters 35 and 36. To a path connecting each of the filters 35 and 36 and the selection terminal 51d therebetween, a switch is not connected in series.

The filter 37 includes at least part of a frequency division duplex (FDD) band in the pass band thereof. The pass band of the filter 37 includes, for example, one of a downlink operating band (2110-2200 MHz) in Band B66 and the downlink operating band (2110-2170 MHz) in Band B1 that are for LTE or one of a downlink operating band (2110-2200 MHz) in Band n66 and the downlink operating band (2110-2170 MHz) in Band n1 that are for 5G-NR.

The input terminal of the filter 37 is connected to the selection terminal 51e of the switch 351. The output terminal of the filter 37 is connected to the radio frequency output terminal 127. To a path connecting the filter 37 and the selection terminal 51e therebetween, a switch is not connected in series.

In this embodiment, the filter 31 includes at least part of the FDD band in the pass band thereof. The pass band of the filter 31 includes, for example, a downlink operating band (1930-1995 MHz) in Band B25 for LTE or a downlink operating band (1930-1995 MHz) in Band n25 for 5G-NR.

The filter 32 includes the downlink operating band (1805-1880 MHz) in Band B3 or Band n3, like Embodiment 1. The filter 33 includes the SDL band in the pass band thereof, like Embodiment 1. The pass band of Specifically, the filter 33 includes Band B32 (1452-1496 MHz), Band n75 (1432-1517 MHz), or Band n76 (1427-1432 MHz).

Each of the filters 38, 39, and 40 is an example of a fifth filter and has a pass band including at least part of the predetermined communication band. The pass bands of the filters are different from each other.

The filter 38 includes the TDD band in the pass band thereof. The pass band of the filter 38 includes, for example, Band B40 (2300-2400 MHz) for LTE or Band n40 (2300-2400 MHz) for 5G-NR.

The input terminal of the filter 38 is connected to the selection terminal 53b of the switch 353. The output terminal of the filter 38 is connected to the radio frequency output terminal 128. To a path connecting the filter 38 and the selection terminal 53b therebetween, a switch is not connected in series.

The filter 39 includes the FDD band in the pass band thereof. The pass band of the filter 39 includes, for example, a downlink operating band (2620-2690 MHz) in Band B7 for LTE or a downlink operating band (2620-2690 MHz) in Band n7 for 5G-NR.

The input terminal of the filter 39 is connected to the selection terminal 53c of the switch 353. The output terminal of the filter 39 is connected to the radio frequency output terminal 129. To a path connecting the filter 39 and the selection terminal 53c therebetween, a switch is not connected in series.

The filter 40 includes the TDD band in the pass band thereof. The pass band of the filter 40 includes, for example, Band B41 (2496-2690 MHz) for LTE or Band n41 (2496-2690 MHz) for 5G-NR.

The input terminal of the filter 40 is connected to the selection terminal 53d of the switch 353. The output terminal of the filter 40 is connected to the radio frequency output terminal 130. To a path connecting the filter 40 and the selection terminal 53d therebetween, a switch is not connected in series.

In this embodiment, the pass band of each of the filters 38, 39, and 40 connected to the switch 353 at the first stage includes a higher frequency band than the pass band of the filters 31, 32, 35, 36, and 37 connected to the switch 351 at the second stage. For example, the pass band of each of the filters 38, 39, and 40 includes a frequency band higher than or equal to 2300 MHz that is also called High band. In contrast, the pass band of each of the filters 31, 32, 35, 36, and 37 includes a frequency band lower than 2300 MHz that is also called Low band, Middle band, or Middle/High band. A radio frequency signal in a high frequency band is largely influenced by the off-state capacitance (parasitic capacitance) of a switch and tends to have high loss due to the off-state capacitance. Accordingly, inclusion of the high frequency band in the pass band of each of the filters 38, 39, and 40 connected to the switch 353 at the first stage enables loss to be reduced.

The configuration described above of the radio frequency circuit 301 is merely an example and is not limited to the example illustrated in FIG. 8. For example, it suffices that the number of selection terminals of the switches 351 and 353 be greater than or equal to 2. The number of filters, the type, the pass band, and the like of the radio frequency circuit 301 are not particularly limited. The example in which the antenna switch has the two-stage configuration having the switches 351 and 353 has been described for the radio frequency circuit 301; however, the antenna switch may be composed of switches at three-stages or more.

### 3.2 Operations

The operations of the radio frequency circuit 301 according to this embodiment will then be described with reference to FIG. 8.

The radio frequency circuit 301 has the single transmission mode and the simultaneous transmission mode.

In the single transmission mode, a radio frequency signal in one communication band is transmitted. Specifically, in the single transmission mode, only one of the filters 31, 32, 35, 36, 37, 38, 39, and 40 operates under the control of the switches 351, 52, and 353.

For example, to operate only the filter 38, the common terminal 53a of the switch 353 is connected to the selection terminal 53b. Likewise, to operate only the filter 39 or 40, it suffices that the common terminal 53a be connected to only one of the selection terminals 53c and 53d.

To operate the filter 31, 35, 36, or 37, the common terminal 53a of the switch 353 is connected to the selection terminal 53e, and the common terminal 51a of the switch 351 is connected to one of the selection terminals 51b and 51d and a selection terminal 51e. To operate only the filter 32, the common terminal 53a of the switch 353 is connected to the selection terminal 53e, the common terminal 51a of the switch 351 is connected to the selection terminal 51c, and the switch 52 is prevented from conducting.

In this embodiment, like Embodiment 1, the filter 33 does not operate alone. That is, the single transmission for only a signal passing through the filter 33 is not performed. The signal passing through the filter 33 is transmitted simultaneously with a signal passing through the filter 32.

In the simultaneous transmission mode, radio frequency signals in a plurality of communication bands are transmitted. Specifically, in the simultaneous transmission mode, two or more filters of the filters 31, 32, and 33 and filters 35, 36, 37, 38, 39, and 40 operate under the control of the switches 351, 52, and 353.

For example, connecting the common terminal 53a of the switch 353 to the selection terminal 53e, connecting the common terminal 51a of the switch 351 to the selection terminal 51c, and allowing the switch 52 to conduct cause two of the filters 32 and 33 to operate. The switches 351 and 353 may each also be a multi-connection switch. In this case, any two or more of the filters 31, 32, 33, 35, 36, 37, 38, 39, and 40 may be transmitted simultaneously.

### 3.3 Advantageous Effects and the Like

As described above, in the radio frequency circuit 301 according to this embodiment, the switch 351 has the common terminal 51a and is capable of performing switching between connection between the common terminal 51a and the selection terminal 51b and connection between the common terminal 51a and the selection terminal 51c. The radio frequency circuit 301 further includes the switch 353 having the selection terminal 53d and the selection terminal 53e and the filter 40 connected to the selection terminal 53d. The common terminal 51a is connected to the selection terminal 53e.

Assuming the filter 31, 35, 36, or 37 operates in the single transmission mode, this causes the off-state capacitance of the switch 52 not to be seen because the filter 33 is connected to the selection terminal 51c with the switch 52 interposed therebetween, like the radio frequency circuit 1 according to Embodiment 1. Accordingly, the number of signals leaking to the filters 32 and 33 may be reduced, and thus loss may be reduced. In addition, since the switch 351 is connected to the switch 353 in the two-stage configuration, the off-state capacitance in the case where the filter 38, 39, or 40 connected to the switch 353 at the first stage operates in the single transmission mode may be reduced further. That is, as compared with a case where a large number of selection terminals are provided to one switch 353, the off-state capacitance may be reduced, and thus loss may be reduced.

### 3.4 Modification

Subsequently, a modification of Embodiment 3 will be described. The description is provided below, focusing on differences from Embodiment 3, and the description of points in common is omitted or simplified.

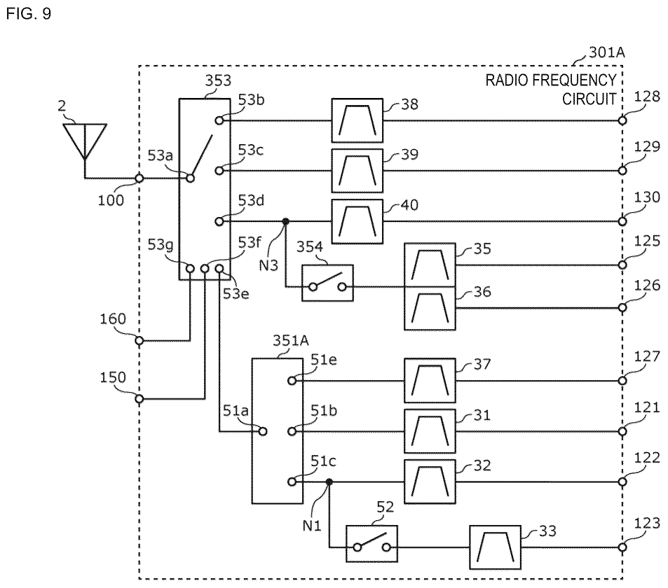

FIG. 9 is a circuit configuration diagram of a radio frequency circuit 301A according to the modification of this embodiment. As illustrated in FIG. 9, as compared with the radio frequency circuit 301 illustrated in FIG. 8, the radio frequency circuit 301A includes a switch 351A instead of the switch 351. The radio frequency circuit 301A also includes a switch 354.

The switch 351A is the same as the switch 351 illustrated in FIG. 8 except a point in that the switch 351A has a smaller number of selection terminals. Specifically, the switch 351A does not have the selection terminal 51d. In this embodiment, each of the filters 35 and 36 connected to the selection terminal 51d in FIG. 8 is an example of a sixth filter and is connected to the selection terminal 53d of the switch 353 with the switch 354 interposed therebetween.

The switch 354 is an example of a fourth switch. The switch 354 is connected in series to and between each of the filters 35 and 36 and the path connecting the selection terminal 53d of the switch 353 and the filter 40. Specifically, the switch 354 is connected in series to and between each of the filters 35 and 36 and a node N3 located on the path connecting the selection terminal 53d and the filter 40. The node N3 may correspond to the selection terminal 53d or the input terminal of the filter 40. The switch 354 is capable of switching between connection and non-connection of the selection terminal 53d (node N3) to one of the filters 35 and 36. The switch 354 is a SPST switch circuit.

As described above, the radio frequency circuit 301A according to this modification further includes the switch 354 and the filter 35 or 36. The switch 354 is connected in series to and between the path connecting the selection terminal 53d and the filter 40 and the filter 35 or 36.

The filters 35 and 36 are thereby connected to the selection terminal 53d, that is, also to the switch 353 at the first stage with the switch 354 interposed therebetween. Accordingly, assuming the filter 38 or 39 operates in the single transmission mode, the off-state capacitance of the switch 354 is not seen. Accordingly, the number of signals leaking to the filters 40, 35, and 36 may be reduced, and thus loss may be reduced. In addition, the number of selection terminals of the switch 351A is reduced, and thus the off-state capacitance of the switch 351A may be reduced. Loss may thereby be reduced.

### Others

The radio frequency circuit and the communication apparatus according to the present disclosure have heretofore been described based on the embodiments above and the like; however, the present disclosure is not limited to the embodiments above.

For example, for Embodiments 1 and 3 and the modifications described above, the example where the radio frequency circuit transmits a reception signal is described; however, the radio frequency circuit may transmit a sending signal. For example, each of the filters 31, 32, and 33 illustrated in FIG. 1 may include the uplink operating band for the communication band in the pass band. That is, the radio frequency circuit does not have to transmit the reception signal.

The followings describe the features of the radio frequency circuits and the communication apparatuses described based on the embodiments above.
<1>

A radio frequency circuit includes:
a first switch having a first selection terminal and a second selection terminal;
a second switch;
a first filter connected to the first selection terminal;
a second filter connected to the second selection terminal; and
a third filter.

The second switch is connected in series to and between the third filter and a path connecting the second selection terminal and the second filter.
<2>

In the radio frequency circuit according to <1>,
the third filter has a pass band including a supplementary downlink (SDL) band.
<3>

In the radio frequency circuit according to <1> or <2>,
the first switch has a common terminal and is capable of performing switching between connection between the common terminal and the first selection terminal and connection between the common terminal and the second selection terminal, and
the second switch is configured to conduct at a time of the connection between the common terminal and the second selection terminal.
<4>

The radio frequency circuit according to any one of <1>to <3> further includes:
a fourth filter having an end connected to a path connecting the second switch and the third filter.
<5>

In the radio frequency circuit according to <1>,
the first filter has a pass band including a first downlink operating band, and
the second filter has a pass band including a second downlink operating band different from the first downlink operating band.

The radio frequency circuit further includes:
a first sending filter that has an end connected to the first selection terminal and that has a pass band including a first uplink operating band; and
a second sending filter that has an end connected to the second selection terminal and that has a pass band including a second uplink operating band.
<6>

In the radio frequency circuit according to <5>,
the third filter has a pass band including a supplementary uplink (SUL) band.
<7>

In the radio frequency circuit according to <5>,
the third filter has a pass band including a third downlink operating band.

The radio frequency circuit further includes:
a third sending filter that has an end connected to a terminal of the second switch on a second filter side of the second switch and that includes a third uplink operating band.
<8>

In the radio frequency circuit according to any one of <1> to <7>,
the first switch has the common terminal and is capable of performing the switching between the connection between the common terminal and the first selection terminal and the connection between the common terminal and the second selection terminal.

The radio frequency circuit further includes:
a third switch having a third selection terminal and a fourth selection terminal; and
a fifth filter connected to the third selection terminal.

The common terminal is connected to the fourth selection terminal.
<9>

The radio frequency circuit according to <8> further includes:
a fourth switch; and a sixth filter.

The fourth switch is connected in series to and between the sixth filter and a path connecting the third selection terminal and the fifth filter.
<10>

In the radio frequency circuit according to any one of <1> to <9>,
the third filter is an auxiliary filter for the second filter.
<11>

A radio frequency circuit includes:
a first switch having a first selection terminal and a second selection terminal;
a second switch;
a first filter connected to the first selection terminal;
a second filter connected to the second selection terminal; and
an external connection terminal.

The second switch is connected in series to and between the external connection terminal and a path connecting the second selection terminal and the second filter.
<12>

A radio frequency circuit includes:
a first switch having a first selection terminal and a second selection terminal;
a second switch of a single pole single throw (SPST) type;
a first filter connected to the first selection terminal;
a second filter connected to the second selection terminal; and
a third filter.

The second switch is connected in series to and between the third filter and a path connecting the second selection terminal and the second filter, and
the third filter has a pass band including a supplementary downlink (SDL) band.
<13>

A communication apparatus includes:
the radio frequency circuit according to any one of <1> to <12>; and
a RF signal processing circuit that processes a radio frequency signal transmitted through the radio frequency circuit.

In addition to the above-described embodiments, a mode obtained by making any of various modifications conceived of by those skilled in the art to the embodiments and a mode achieved by performing any combination of the components and the functions in the embodiments without departing from the spirit of the present disclosure are included in the embodiments of the present disclosure.

### INDUSTRIAL APPLICABILITY

The present disclosure is widely usable as a front end circuit or the like supporting multiband/multimode, for communication apparatuses such as a mobile phone.

### REFERENCE SIGNS LIST

1, 1A, 1B, 1C, 201, 201A, 301, 301A radio frequency circuit
2 antenna
3 RFIC
4, 204 communication apparatus
11, 12, 13 power amplifier
21, 22, 23 low-noise amplifier
31, 32, 33, 34, 35, 36, 37, 38, 39, 40, 63 filter
51, 52, 351, 351A, 353, 354 switch
51a, 53a common terminal
51b, 51c, 51d, 51e, 53b, 53c, 53d, 53e, 53f, 53g selection terminal
61, 62, 73 duplexer
61R, 62R, 73R reception filter
61T, 62T, 73T sending filter
80 stub
100 antenna connection terminal
111, 112, 113 radio frequency input terminal
121, 122, 123, 124, 125, 126, 127, 128, 129, 130 radio frequency output terminal
140, 150, 160 external connection terminal
N1, N2, N3 node

1. A radio frequency circuit comprising:
a first switch having a first selection terminal and a second selection terminal;
a second switch;
a first filter connected to the first selection terminal;
a second filter connected to the second selection terminal; and
a third filter,
wherein the second switch is connected in series to and between the third filter and a path connecting the second selection terminal and the second filter.

2. The radio frequency circuit according to claim 1,
wherein the third filter has a pass band including a supplementary downlink (SDL) band.

3. The radio frequency circuit according to claim 2,
wherein the first switch has a common terminal and is capable of performing switching between connection between the common terminal and the first selection terminal and connection between the common terminal and the second selection terminal, and
wherein the second switch is configured to conduct at a time of the connection between the common terminal and the second selection terminal.

4. The radio frequency circuit according to claim 3, further comprising:
a fourth filter having an end connected to a path connecting the second switch and the third filter.

5. The radio frequency circuit according to claim 1,
wherein the first filter has a pass band including a first downlink operating band, and
wherein the second filter has a pass band including a second downlink operating band different from the first downlink operating band,
the radio frequency circuit further comprising:
a first sending filter that has an end connected to the first selection terminal and that has a pass band including a first uplink operating band; and
a second sending filter that has an end connected to the second selection terminal and that has a pass band including a second uplink operating band.

6. The radio frequency circuit according to claim 5,
wherein the third filter has a pass band including a supplementary uplink (SUL) band.

7. The radio frequency circuit according to claim 5,
wherein the third filter has a pass band including a third downlink operating band,
the radio frequency circuit further comprising:
a third sending filter that has an end connected to a terminal of the second switch on a second filter side of the second switch and that includes a third uplink operating band.

8. The radio frequency circuit according to claim 7,
wherein the first switch has the common terminal and is capable of performing the switching between the connection between the common terminal and the first selection terminal and the connection between the common terminal and the second selection terminal,
the radio frequency circuit further comprising:
a third switch having a third selection terminal and a fourth selection terminal; and
a fifth filter connected to the third selection terminal, wherein the common terminal is connected to the fourth selection terminal.

9. The radio frequency circuit according to claim 8, further comprising:
a fourth switch; and a sixth filter,
wherein the fourth switch is connected in series to and between the sixth filter and a path connecting the third selection terminal and the fifth filter.

10. The radio frequency circuit according to claim 9,
wherein the third filter is an auxiliary filter for the second filter.

11. A radio frequency circuit comprising:
a first switch having a first selection terminal and a second selection terminal;
a second switch;
a first filter connected to the first selection terminal;
a second filter connected to the second selection terminal; and
an external connection terminal,
wherein the second switch is connected in series to and between the external connection terminal and a path connecting the second selection terminal and the second filter.

12. A radio frequency circuit comprising:
a first switch having a first selection terminal and a second selection terminal;
a second switch of a single pole single throw (SPST) type;
a first filter connected to the first selection terminal;
a second filter connected to the second selection terminal; and
a third filter,
wherein the second switch is connected in series to and between the third filter and a path connecting the second selection terminal and the second filter, and
wherein the third filter has a pass band including a supplementary downlink (SDL) band.

13. A communication apparatus comprising:
the radio frequency circuit according to claim 12; and
a radio frequency (RF) signal processing circuit that processes a radio frequency signal transmitted through the radio frequency circuit.

14. A communication apparatus comprising:
the radio frequency circuit according to claim 1; and
a radio frequency (RF) signal processing circuit that processes a radio frequency signal transmitted through the radio frequency circuit.

15. A communication apparatus comprising:
the radio frequency circuit according to claim 11; and
a radio frequency (RF) signal processing circuit that processes a radio frequency signal transmitted through the radio frequency circuit.

16. The radio frequency circuit according to claim 1,
wherein the first switch has a common terminal and is capable of performing switching between connection between the common terminal and the first selection terminal and connection between the common terminal and the second selection terminal, and
wherein the second switch is configured to conduct at a time of the connection between the common terminal and the second selection terminal.

17. The radio frequency circuit according to claim 1, further comprising:
a fourth filter having an end connected to a path connecting the second switch and the third filter.

18. The radio frequency circuit according to claim 2, further comprising:
a fourth filter having an end connected to a path connecting the second switch and the third filter.

19. The radio frequency circuit according to claim 1,
wherein the first switch has the common terminal and is capable of performing the switching between the connection between the common terminal and the first selection terminal and the connection between the common terminal and the second selection terminal,
the radio frequency circuit further comprising:
a third switch having a third selection terminal and a fourth selection terminal; and
a fifth filter connected to the third selection terminal, wherein the common terminal is connected to the fourth selection terminal.

20. The radio frequency circuit according to claim 2,
wherein the first switch has the common terminal and is capable of performing the switching between the connection between the common terminal and the first selection terminal and the connection between the common terminal and the second selection terminal,
the radio frequency circuit further comprising:
a third switch having a third selection terminal and a fourth selection terminal; and
a fifth filter connected to the third selection terminal, wherein the common terminal is connected to the fourth selection terminal.
